(19) United States
(12) Patent Application Publication
(10) Pub. No.: US 2014/0211642 A1
(43) Pub. Date: Jul. 31, 2014

(54) Method And System For Boosting Transmission Settings Based On Signal To Interference And Noise Ratio

(71) Applicant: QUALCOMM INCORPORATED, San Diego, CA (US)

(72) Inventors: Shu Du, Milpitas, CA (US); Zhanfeng Jia, Belmont, CA (US); Ning Zhang, Saratoga, CA (US); Qinghai Gao, Sunnyvale, CA (US)

(73) Assignee: Qualcomm Incorporated, San Diego, CA (US)

(21) Appl. No.: 13/754,823

(22) Filed: Jan. 30, 2013

(51) Int. Cl. H04W 72/08

(52) U.S. Cl. CPC H04W 72/085
USPC 370/252; 370/329

(57) ABSTRACT

A method of performing transmission from an access point (AP) in a wireless communication system provides transmission setting adjustment after sounding. In this method, stations associated with the AP and having transmission data can be identified. Transmission to those stations can be performed using a predetermined transmission setting. For a first transmission after a sounding, the predetermined transmission setting can be boosted. For any transmission other than the first transmission after the sounding, a current or adjusted transmission setting can be used based on a detected PER during transmission. An adjusted transmission setting can be an MCS rate, a user-level (SU-BF, 2U-MIMO, or 3U-MIMO), or an aggregated MAC protocol data unit (AMPDU) aggregation level. A single transmission setting or a combination of settings can be used. The method can be used with any transmission setting(s), including those mapped from the Signal to Interference and Noise Ratio (SINR).

### BACKGROUND

The invention relates generally to transmission setting control, and in particular to boosting transmission settings based on signal to interference and noise ratio in multi-user wireless systems.

### RELATED ART

IEEE 802.11 refers to a set of standards for implementing wireless local area network (WLAN) communication in the 2.4, 3.6, and 5 GHz frequency bands. WLAN communication allows a device to exchange data wirelessly with one or more other devices. WiFi™ is a brand name for WLAN products using any of the IEEE 802.11 standards.

IEEE 802.11ac is a new standard being developed to support Very High Throughput (VHT) operations in the 5 GHz frequency band. To obtain this VHT operation, an 802.11ac device uses a wide RF (radio frequency) bandwidth, up to 8 spatial streams using multiple antennas at both the transmitter and receiver (called multiple-input multiple-output or MIMO in the wireless industry), thereby allowing a terminal to transmit or receive signals to/from multiple users in the same frequency band simultaneously. VHT operation also uses a high-density modulation of up to 256 QAM (quadrature amplitude modulation).

Beamforming is a technique using directional signal transmission or reception with multiple antennas to achieve spatial selectivity. For example, a transmitter can control the phase and amplitude of the signals at each antenna to create a pattern of constructive and destructive interference in the wavefront.

To correctly form a beam for MIMO communication, the transmitter needs to know the characteristics of the channel. To obtain these channel characteristics, the transmitter can send a known signal to a device, which allows that device to generate information regarding the current quality of the channel. The device can then send this channel state information (CSI) back to the transmitter, which in turn can apply the correct phases and amplitudes to form the optimized beam directed at the device. This process is called channel sounding or channel estimation (referenced as the sounding process herein).

In 802.11ac communication, an access point (AP) can use the sounding process to collect CSI from one or more potential destination stations. Thereafter, the AP can use the collected CSI as the current channel estimation to send downlink data to multiple stations in a multiple user MIMO (MU-MIMO) frame. Note also that the collected CSI can be used to send downlink data to one station in a SU-MIMO frame, wherein SU-MIMO is a single-user MIMO (a beamforming technique using multiple antennas at one station).

When the SU-BF or MU-MIMO data is sent out immediately after a sounding process (e.g., within 1-10 mSec), the CSI information used for SU-BF/MU-MIMO data transmission is fresh, and the packet will have a higher chance to be delivered successfully. On the other hand, if the SU-BF/MU-MIMO data is sent out even a brief time after the last sounding process, the CSI information used in generating SU-BF or MU-MIMO data transmission can be stale and the packet may have a lower chance of being delivered successfully.

Depending upon channel condition or MU-MIMO level (2-user or 3-user), SINR (signal to interference noise ratio) of 3-user MU-MIMO, 2-user MU-MIMO, and SU-BF transmissions can differ substantially, even if the CSI information has the same age.

The situation gets even more complicated in that, under different channel conditions, for example, with Doppler and without Doppler, the SINR gaps among 3-user MU, 2-user MU, and SU-BF can be markedly different as well. These variations make transmission setting selection even more difficult.

The difficulty of selecting and using an optimum transmission setting frequently results in a missing of existing but subtle opportunities. The phrases “transmission setting,” “transmit setting,” and “TX setting” have the same meaning and are used interchangeably at various times within this document. A transmission setting can include, but is not limited to, a transmission rate (e.g., an MCS rate), a number of users (e.g., 2-user MIMO, and 3-user MIMO), beamforming and non-beamforming modes of operation, and aggregation levels of an aggregated MAC protocol data unit (AMPDU). What is needed is a transmission setting control strategy that takes advantage of such opportunities by leveraging increases in the SINR following a sounding.

### SUMMARY OF THE EMBODIMENTS

A transmission setting adaptation (control) method can take advantage of opportunities existing immediately following a channel sounding. When the CSI is not older than approximately 10-20 mSec, various transmission settings can be boosted slightly, and the boost often succeeds in improving system throughput. Even slight and temporary gains of this nature can enhance system operation significantly.

A method for performing data transmission from an access point in a wireless communication system is provided. The method identifies stations associated with the access point having transmission data, and transmits the data using a predetermined TX setting. The TX setting is boosted (i.e., increased) for a first transmission after a sounding, and for transmissions other than the first, the method uses a current TX setting or lowers the setting depending upon a detected packet error rate (PER) for a preceding transmission, or the time elapsed since the last sounding.

Additionally, a method is provided in which the TX setting is at least one of an MCS level, a transmission type (i.e., 3U-MIMO, 2U-MIMO, and SU-BF), and an AMPDU aggregation level. Also, a method is provided in which the TX setting is any transmission setting mapped from a Signal to Interference and Noise Ratio (SINR). Further described is a computer-readable media storing computer instructions that when executed carry out the described rate boosting method. A wireless communication device for performing the described rate boosting method is also provided.

### BRIEF DESCRIPTION OF THE DRAWINGS

FIG. 1A illustrates a small basic service set (BSS) including an AP and two stations, STA1 and STA2.

FIG. 1B illustrates an exemplary communication between the AP and the stations STA1 and STA2 shown in FIG. 1A, including a sounding process for establishing current communication channel quality.

FIG. 2 illustrates an exemplary communication between the AP and the stations STA1 and STA2 shown in FIG. 1A, including a first sounding process followed by a plurality of data processes, and then a second sounding process.

FIG. 3 illustrates results of a simulation comparing Packet Error Rate (PER) versus a time delay since most recent sounding for communications using different modulation and coding schemes (MCS) in a BSS such as illustrated in FIG. 1A.

FIG. 4 illustrates an exemplary method for adjusting a transmission setting in the BSS illustrated in FIG. 1A.

FIG. 5 illustrates a simplified electronic device including a rate control block that can perform the rate adjustment method shown in FIG. 4.

### DETAILED DESCRIPTION OF THE DRAWINGS

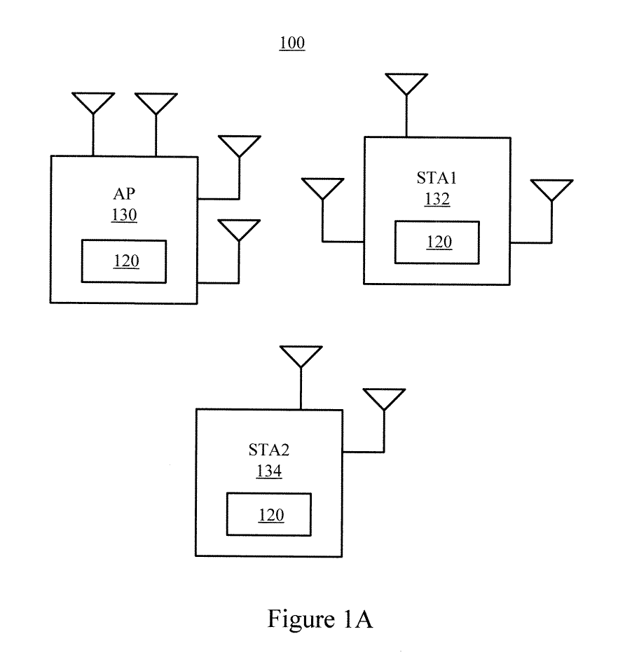

FIG. 1A illustrates a small basic service set (BSS) 100 including an AP 130 and two stations STA1 132 and STA2 134. In one embodiment, each device includes a transceiver 120 (transmitter and receiver) configured for operation in accordance with the IEEE 802.11ac standard.

FIG. 1B illustrates an exemplary communication between the AP 130 and the stations STA1 132 and STA2 134 of FIG. 1A. This exemplary communication can be characterized as including two processes: a sounding process 110 and a data process 111. Sounding process 110 begins with the AP 130 sending a null data packet announcement (NDPA) signal 101 to stations STA1 132 and STA2 134, wherein the NDPA signal 101 indicates that no data will be sent in the subsequent packet. Following the NDPA signal 101, the AP 130 sends a null data packet (NDP) signal 102. This NDP signal 102 can serve as a known signal for obtaining channel characteristics from the stations STA1 132 and STA2 134. In accordance with the 802.11ac standard, after receipt of NDP signal 102, station STA1 132 sends its CSI in a beamforming (BF) report1 signal 103. Then, the AP 130 sends a BF poll signal 104 indicating that the station STA2 134 can send its channel characteristics. Then, the station STA2 134 sends its CSI in a BF report2 signal 105.

Using the CSI from its associated stations STA1 132 and STA2 134, the AP 130 can begin the data process 111 by simultaneously sending MU-MIMO data 106 to station STA1 132 and MU-MIMO data 107 to station STA2 134. Note that although the term MU-MIMO is used to describe the data, the data may also be SU-MIMO in other embodiments. After receiving the data 106, the station STA1 132 can send a block acknowledgement (BA) signal 108; the AP 130 can send a block acknowledgement request (BAR) signal 109 for the station STA2 134; and the station STA2 134 can send its BA signal 110 in response. Note that although FIG. 1A shows an AP 130 associated with two stations 132 and 134, in other embodiments the AP 130 can be associated with any number of stations, each of which can send a BF report signal during the sounding process 110 and a BA signal during the data process 111.

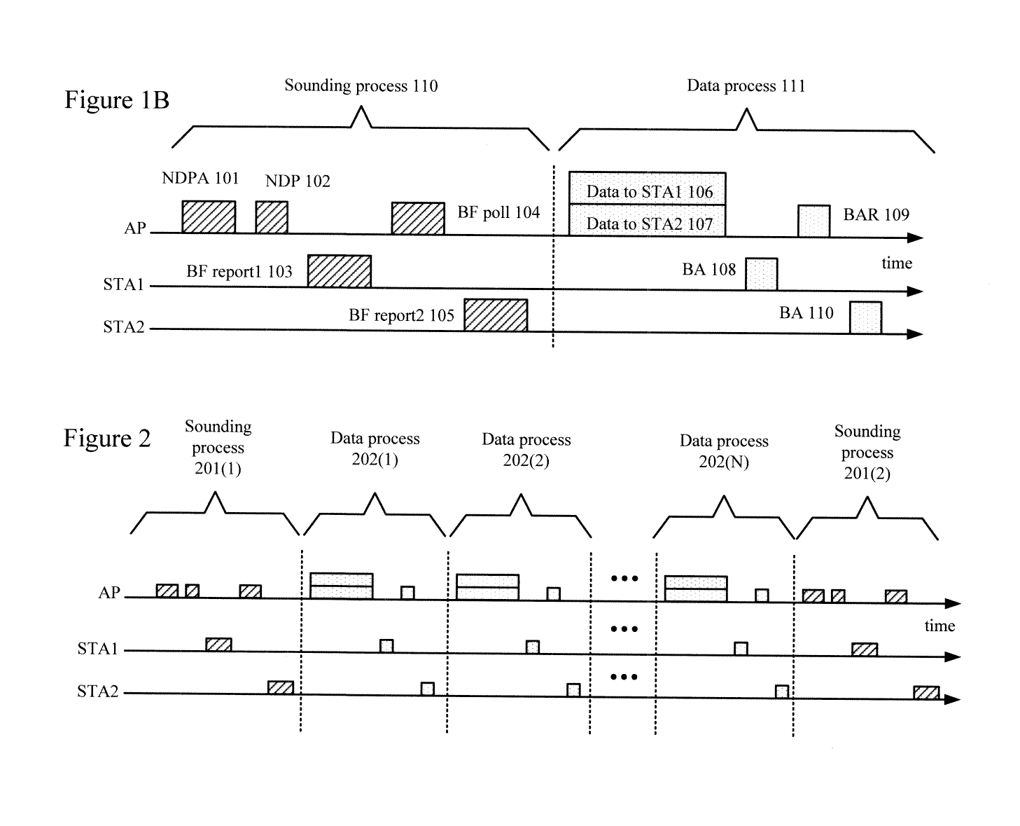

Because the sounding process has a large overhead in terms of medium airtime, the AP 130 may be configured not to do sounding prior to every MU-MIMO data transmission, as for example in FIG. 2.

FIG. 2 illustrates a first sounding process 201(1) followed by a plurality of data processes 202(1)-202(N), wherein N is an integer greater than 2. After the N data processes are complete, a second sounding process 202(2) is performed before another plurality of data processes are performed (not shown).

Although a maximum data rate is generally desired, a possible data rate for a transmission is limited by the number of spatial streams used in the transmission, the modulation type, and the coding rate. The number of spatial streams, modulation type, coding rate, and resulting maximum data rates form part of a modulation and code scheme (MCS). The IEEE 802.11 family of standards defines various modulation and coding schemes, and represents them by index values. Table 1 below (taken from IEEE 802.11n) shows exemplary MCS index values and their respective spatial streams, modulation types, coding rates, and resulting maximum data rates. Note that data rates are provided for both 20 MHz and 40 MHz channels, as well as 800 ns and 400 ns guard intervals (GIs).

TABLE 1

| | | | | Data rate (Mbit/s) | | | |
|---|---|---|---|---|---|---|---|
| | | | | 20 MHz | | 40 MHz | |
| | | Modu- | | channel | | channel | |
| | Spatial | lation | Coding | 800 ns | 400 ns | 800 ns | 400 ns |
| MCS | streams | type | rate | GI | GI | GI | GI |
| 0 | 1 | BPSK | ½ | 6.50 | 7.20 | 13.50 | 15.00 |
| 10 | 2 | QPSK | ¾ | 39.00 | 43.30 | 81.00 | 90.00 |
| 19 | 3 | 16- | ½ | 78.00 | 86.70 | 162.00 | 180.00 |
| | | QAM | | | | | |
| 31 | 4 | 64- | ⅚ | 260.00 | 288.80 | 540.00 | 600.00 |
| | | QAM | | | | | |

The transmitter attempts to determine the best MCS to send the data frames. Using a higher MCS may cause some receivers to fail to decode the data frames, thereby increasing the PER. However, using a lower MCS may cause inefficiency in medium usage and network congestion. Therefore, choosing a proper MCS for data frame transmissions is a tradeoff between reliability and efficiency.

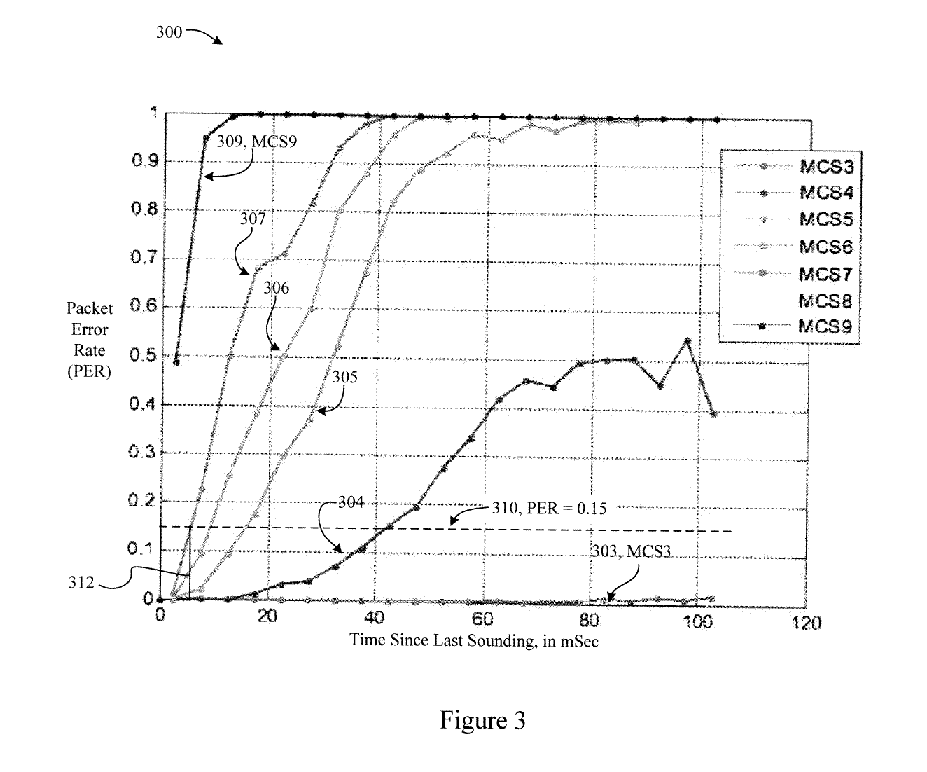

FIG. 3 illustrates a graph 300 showing results of a simulation in a BSS such as illustrated in FIG. 1A, comparing Packet Error Rate (PER) versus a time delay since most recent sounding. The simulation illustrates an advantage to be gained by boosting a modulation and coding scheme (MCS) level. The simulation results include a series of performance curves 303-309, corresponding respectively to MCS level-3 (MCS3) through MCS level-9 (MCS9). No curve is shown for MCS level-8. The vertical axis corresponds to a Packet Error Rate (PER), and the horizontal axis corresponds to a time, expressed in mSec, since a most recent sounding (the age of the CSI). Dashed horizontal line 310 illustrates a constant PER level of 0.15 (a 15 percent error rate). Vertical line 312, located in the lower left-hand corner of FIG. 3, corresponds to an age of approximately 6 mSec, and to a point on curve 307 (MCS7) at which a simulated PER equals 0.15.

Examination of the lower left-hand corner of FIG. 3 reveals that when previously operating at an MCS6 level, and when the time since a most recent sounding is 6 mSec or less, the transmission rate can be boosted one level to MCS7 without exceeding a packet error rate of 0.15. And, if fact, any rate lower than MCS6 can be boosted one level, or in some cases, by even more than one level. A conservative conclusion is that an MCS level can be boosted to a new level when the CSI age permits the increase without the expected PER at the new level exceeding a predetermined threshold, e.g., the 0.15 threshold level.

In an example to illustrate this point, assume transmission has been taking place at MCS4 and that approximately 10 mSec have elapsed since the previous sounding. Assume also that it is desirable to limit the packet error rate to no more than 10 percent (i.e., PER 0.1). Examination of the lower left-hand portion of FIG. 3 reveals that a boost to a level of MCS5 (curve 305) is possible without exceeding the 10 percent level (and maybe less than 5 percent level).

Though not immediately evident from an examination of graph 300 of FIG. 3, other changes in transmission setting can also be made, either singly or in combination, to improve communication speed without exceeding a PER threshold. For example, rather than boosting the MCS level by one, the MU level can be boosted by one. For example, if operating in a 2-user mode, a boost to 3-user mode can be made. Or, if operating in an SU-BF mode, a boost to the two-user MIMO mode will be permitted. Alternatively, an AMPDU aggregation level can be boosted. In summary, several strategies to leverage fresh CSI after a sounding to further improve overall network performance are described below.

However, in some embodiments, the first strategy may be to boost an MCS level after a sounding. After a sounding to the specific destination(s), the sender increases the transmission rate (e.g., increases the MCS level by 1) to the destination for the next data transmission. If the transmission fails or incurs a too high packet error rate (greater than some threshold, e.g., PER >0.15) for the included MPDUs, the rate is dropped back to the previous rate.

Another strategy is to boost the MU level after a sounding. In general, the aggregated rate of all users in MU-MIMO has a higher value than an aggregated rate for SU-BF. Also, in general, the aggregated rate for a 3-user MU-MIMO has a higher value than a 2-user MU-MIMO. After a sounding to the specific destination(s), the sender increases the MU level to the specific destination(s). For example, if previously, the sender was using SU-BF to the destination, the sender advances to 2-user MU-MIMO to the same destination plus some other node, in order to form the 2-user transmission. If previously the sender was using 2-user MU-MIMO to the destination(s), the sender advances to 3-user MU-MIMO. Still, if after the MU-level boosting, the new AMPDU transmission fails or incurs a high PER (greater than some threshold) for the included MPDUs, the MU level can then be dropped back to the previous settings.

A third strategy is to boost the AMPDU aggregation level after a sounding. After a sounding to the specific destination(s), the sender increases the AMPDU aggregation level to include more MPDUs in a single AMPDU. On the other hand, if the new transmission fails or incurs a high PER (greater than some threshold) for the included MPDUs, the aggregation level is returned to the previous value.

The above three strategies can be used alone or in combination following a sounding. Also, other than the three mentioned mechanisms, there are other ways of transmission boosting after the sounding. For example, if the AP used a reserved transmission opportunity (TXOP) to send multiple AMPDUs to a STA, then after the sounding to the specific STA, the AP can boost (increase) the TXOP duration. In general, sounding provides fresh CSI for the destinations, and can improve the SINR for the next data transmission to those destination(s). As a result, any TX settings that can be mapped directly from SINR, such as, e.g., MCS, MU level, and AMPDU aggregation level, can be boosted in this manner.

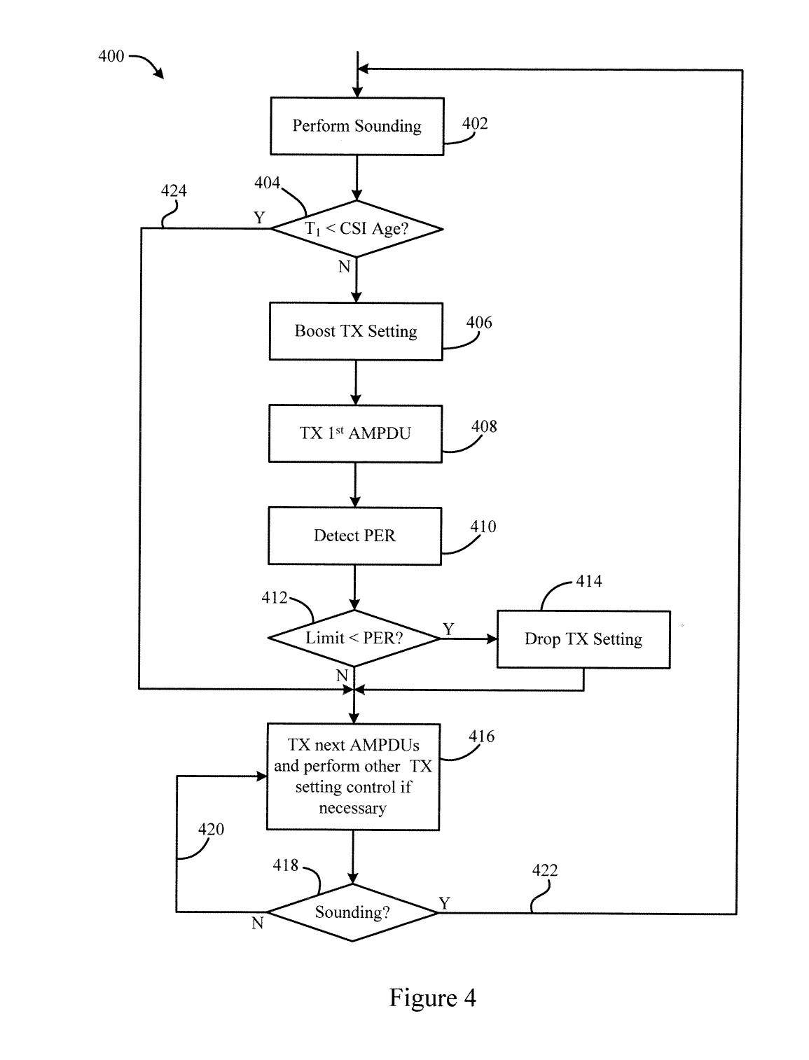

FIG. 4 illustrates an exemplary method 400 for adjusting a transmission setting(s) to obtain the advantage illustrated in the simulation results of FIG. 3. The adjustment is performed following a sounding and before data is transmitted.

At 402 a sounding is performed to determine channel performance. A test is made at step 404 to determine whether the time since the most previous sounding exceeds a limit, T₁, e.g., 10 mSec. If the age of the CSI does not exceed T₁, the method advances to 406. When the age of the CSI is greater than T1, the method advances via path 424 to 416. The CSI age test prevents boosting when channel condition information is stale, as can occur when multiple soundings are performed to different stations before data transmission begins.

Referring back to FIG. 4, at least one transmission setting (e.g., an MCS level, a MU beam-forming level, and/or an AMPDU aggregation level) is adjusted at 406, and at 408 a first AMPDU following the sounding is transmitted using the adjusted transmission setting(s). Proceeding to 410, a packet error rate (PER) for the first AMPDU is detected, and in 412 the AMPDU is compared with a limit value. An example of the limit value is a 0.15 PER value (line 310 of the graph 300 of FIG. 3). If the PER of the first AMPDU following the sounding exceeds the limit value (Y), at least one of the transmission parameters (TX Setting) is reduced to a lower value at 414. In some embodiments, the transmission parameters that were adjusted at 406 are reverted to their pre-adjustment values. For example, if a TX Setting was boosted at 406, and the resulting PER was found to exceed the limit at 412, the TX Setting can be reverted to its pre-adjustment level at 414. In other embodiments, the adjustments in 414 may be to levels between the current value and pre-adjustment value or a combination of reverting one setting while maintaining another setting.

At 416, a next AMPDU is transmitted using the resulting transmission setting(s) (i.e., either the adjusted levels if the test at 412 results in a NO, or the reduced levels if the test at 412 results in a YES). 416 also indicates that other TX Setting control can be applied, but such other control is not part of the boosting strategies described above with respect to 402 through 414 (e.g., adjusting an MU-basic rate following an in-loop sounding, and adjusting an AMPDU duration based on performance statistics).

Proceeding to 418, a test is made to determine whether a new sounding must be performed, and if NO, the return path 420 returns control to 416 and the process continues until all the data has been transmitted or until otherwise terminated. Note that, in some embodiments, the adjustment strategies (e.g., increase at 406, decrease at 414) occur only following a sounding (402). Otherwise, when a new sounding is required because the CSI has become too stale, return path 422 returns control to 402 for Performing a new sounding. In one embodiment, the CSI will be considered too stale, necessitating a new sounding, when the age of the CSI exceeds 200 mSec for SU-BF and 50 mSec for MU-MIMO.

In some embodiments, a method of performing transmission from an access point (AP) in a wireless communication system, such as the method 400 illustrated in FIG. 4, includes identifying stations associated with the AP and having transmission data (e.g., FIGS. 1B and 2). The AP performs transmission to the stations using predetermined TX Settings, and for a first transmission after a sounding, adjusts a TX Setting (e.g., 406, 408). For any transmission other than the first transmission after the sounding (e.g., 416), using an adjusted TX Setting (e.g., 406), or a lower TX Setting (e.g., 414), based on a PER during transmission (e.g., 410).

Certain aspects of the TX Setting adjustment method 400, as illustrated in FIG. 4, may take the form of an entirely software embodiment (including firmware, resident software, micro-code, etc.) or an embodiment combining software and hardware aspects that may all generally be referred to herein as a “circuit,” “module” or “system.” Furthermore, embodiments of the disclosure may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not. A machine-readable medium includes any mechanism for storing (“machine-readable storage medium”) or transmitting (“machine-readable signal medium”) information in a form (e.g., software, processing application) readable by a machine (e.g., a computer). The machine-readable storage medium may include, but is not limited to, magnetic storage medium (e.g., floppy diskette), optical storage medium (e.g., CD-ROM), magneto-optical storage medium, read only memory (ROM), random access memory (RAM), erasable programmable memory (e.g., EPROM and EEPROM), flash memory, or other types of medium suitable for storing electronic instructions (e.g., executable by one or more processing units). In addition, machine-readable signal medium embodiments may be embodied in an electrical, optical, acoustical, or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

Although the transmission setting boosting methods can be performed by an AP, an electronic device having wireless capability typically includes certain components that may or may not be characterized as part of an AP. Indeed, in some embodiments, certain components of the electronic device may be characterized as outside the AP, but still assist in one or more steps of the data scheduling technique.

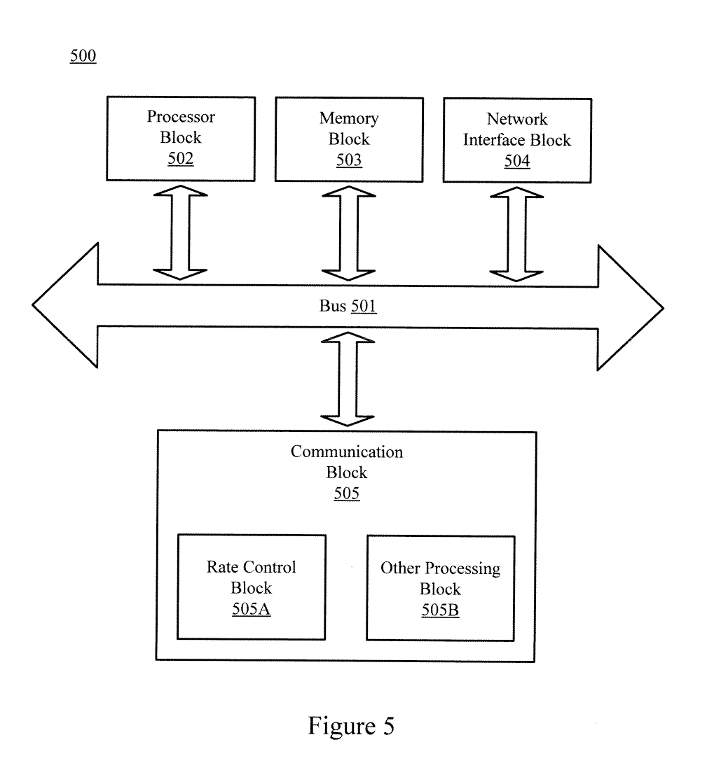

FIG. 5 illustrates a simplified electronic device 500 including a rate control block 505A, which can substantially perform the transmission setting adjustment method 400. The electronic device 500 may be a notebook computer, a desktop computer, a tablet computer, a netbook, a mobile phone, a gaming console, a personal digital assistant (PDA), or other electronic system having wireless (and wired, in some cases) communication capabilities.

The electronic device 500 can include a processor block 502 (possibly including multiple processors, multiple cores, multiple nodes, and/or implementing multi-threading, etc.). The electronic device 500 can also include a memory block 503, which may include cache, SRAM, DRAM, zero capacitor RAM, Twin Transistor RAM, eDRAM, EDO RAM, DDR RAM, EEPROM, NRAM, RRAM, SONOS, PRAM, and/or another type of memory cell array. The electronic device 500 also includes a network interface block 504, which may include at least a WLAN 802.11 interface. Other network interfaces may include a BLUETOOTH® (Bluetooth) interface, a WiMAX interface, a ZigBee® interface, a Wireless USB interface, and/or a wired network interface (such as an Ethernet interface, or a powerline communication interface, etc.). The processor block 502, the memory block 503, and the network interface block 504 are coupled to a bus 501, which may be implemented in accordance with PCI, ISA, PCI-Express, HyperTransport®, InfiniBand®, NuBus, AHB, AXI, or another bus standard.

The electronic device 500 also includes a communication block 505, which can include a TX Setting control block 505A and another processing block 505B. The other processing block 505B may include, but is not limited to, portions of a transceiver for processing received signals, for processing to be transmitted signals, and for coordinating actions of the receiver and transmitter portions. Other embodiments may include fewer or additional components not illustrated in FIG. 5, such as video cards, audio cards, additional network interfaces, and/or peripheral devices. In one embodiment, the memory block 503 may be connected directly to the processor block 502 to increase system processing.

The above description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. For example, although selecting a data rate is described in detail above, this selection can be characterized as also selecting an MCS (modulation and coding scheme)(see TABLE I). Thus, the present invention is not intended to be limited to the embodiments shown herein but is to be accorded the widest scope consistent with the principles and novel features disclosed herein.

1. A method of performing transmission from a data transmitting source in a wireless communication system, the method comprising:
performing a sounding with a data receiving source in the wireless communication system;
adjusting a predefined transmission setting based on the sounding in order to increase a transmission speed; and
transmitting data to the data receiving source using the adjusted transmission setting.

2. The method of claim 1, wherein the data transmitting source is an access point (AP) in a basic service set and the data receiving source is a station in the basic service set.

3. The method of claim 1, wherein the predefined transmission setting comprises at least one of a modulation and coding scheme level, a transmission type, and an aggregated media access control (MAC) protocol data unit (AMPDU) aggregation level.

4. The method of claim 3, wherein the transmission type comprises one of single user beam forming (SU-BF), two user multiple input multiple output (MU 2-user), and three user multiple input multiple output (MU 3-user).

5. The method of claim 4, wherein adjusting the transmission setting comprises increasing the predefined transmission setting by a predetermined amount.

6. The method of claim 5, further comprising determining if an age of current sounding information (CSI) exceeds a predefined threshold, wherein the predefined transmission setting is adjusted if the age does not exceed the predefined threshold.

7. The method of claim 6, wherein the predefined threshold depending upon the transmission type comprises:
30 mSec for SU-BF;
10 mSec for MU 2-user; and
5 mSec for MU 3-user.

8. The method of claim 2, further comprising:
determining a packet error rate (PER) for transmission of the data to the station;
determining if the PER exceeds a predefined threshold;
if the PER exceeds the predefined threshold, readjusting the adjusted transmission setting in order to decrease the transmission speed and transmitting data to the station using the readjusted transmission setting; and
if the PER does not exceed the predefined threshold, transmitting data to the station using the adjusted transmission setting.

9. The method of claim 8, wherein readjusting the adjusted transmission setting comprises reverting the adjusted transmission setting to the predefined transmission setting.

10. The method of claim 9, wherein the adjusted transmission setting comprises at least one of a modulation and coding scheme level, a transmission type, and an aggregated media access control (MAC) protocol data unit (AMPDU) aggregation level.

11. The method of claim 10, wherein the transmission type further comprises one of single user beam forming (SU-BF), two user multiple input multiple output (MU 2-user), and three user multiple input multiple output (MU 3-user).

12. A non-transitory, computer-readable medium storing computer-executable instructions for communicating in a data transmitting source of a multi-user wireless communication system, the instructions when executed by a processor causing the processor to execute a process comprising:
performing a sounding with a data receiving source in the wireless communication system;
adjusting a predefined transmission setting based on the sounding in order to increase a transmission speed; and
transmitting data to the data receiving source using the adjusted transmission setting.

13. The computer-readable medium of claim 12, wherein the data transmitting source is an access point (AP) in a basic service set and the data receiving source is a station in the basic service set.

14. The computer-readable medium of claim 12, wherein the predefined transmission setting comprises at least one of a modulation and coding scheme level, a transmission type, and an aggregated media access control (MAC) protocol data unit (AMPDU) aggregation level.

15. The computer-readable medium of claim 14, wherein the transmission type comprises one of single user beam forming (SU-BF), two user multiple input multiple output (MU 2-user), and three user multiple input multiple output (MU 3-user).

16. The computer-readable medium of claim 15, wherein adjusting the predefined transmission setting comprises increasing the transmission setting by a predetermined amount.

17. The computer-readable medium of claim 16, further comprising determining if an age of current sounding information (CSI) exceeds a predefined threshold, wherein the predefined transmission setting is adjusted if the age does not exceed the predefined threshold.

18. The computer-readable medium of claim 17, wherein the predefined threshold depending upon the transmission type comprises:
30 mSec for SU-BF;
10 mSec for MU 2-user; and
5 mSec for MU 3-user.

19. The computer-readable medium of claim 13, further comprising:
determining a packet error rate (PER) for transmission of the data to the station;
determining if the PER exceeds a predefined threshold;
if the PER exceeds the predefined threshold, readjusting the adjusted transmission setting in order to decrease the transmission speed and transmitting data to the station using the readjusted transmission setting; and
if the PER does not exceed the predefined threshold, transmitting data to the station using the adjusted transmission setting.

20. The computer-readable medium of claim 19, wherein readjusting the transmission setting comprises reverting the adjusted transmission setting to the predefined transmission setting.

21. The computer-readable medium of claim 20, wherein the adjusted transmission setting comprises at least one of a modulation and coding scheme level, a transmission type, and an aggregated media access control (MAC) protocol data unit (AMPDU) aggregation level.

22. The computer-readable medium of claim 21, wherein the transmission type further comprises one of single user beam forming (SU-BF), two user multiple input multiple output (MU 2-user), and three user multiple input multiple output (MU 3-user).

23. A device for performing transmission in a wireless communication system, comprising:
means for performing a sounding with a data receiving source in the wireless communication system;
means for adjusting a predefined transmission setting based on the sounding in order to increase a transmission speed; and
means for transmitting data to the data receiving source using the adjusted transmission setting.

24. The device of claim 23, wherein the data transmitting source is an access point (AP) in a basic service set and the data receiving source is a station in the basic service set.

25. The device of claim 23, further comprising means for mapping the predefined transmission setting from a Signal to Interference and Noise Ratio (SINR).

26. The device of claim 25, wherein the predefined transmission setting comprises at least one of a modulation and coding scheme level, a transmission type, and an aggregated media access control (MAC) protocol data unit (AMPDU) aggregation level.

27. The device of claim 26, wherein the transmission type comprises one of single user beam forming (SU-BF), two user multiple input multiple output (MU 2-user), and three user multiple input multiple output (MU 3-user).
